(19) United States
(12) Patent Application Publication
(10) Pub. No.: US 2008/0222714 A1
(43) Pub. Date: Sep. 11, 2008

(54) System and method for authentication upon network attachment

(76) Inventor: Mark Frederick Wahl, Austin, TX (US)

Correspondence Address: Mark Wahl, PO Box 90626, Austin, TX, 78709, US

(21) Appl. No.: 12/074,041

(22) Filed: Mar. 1, 2008

Related U.S. Application Data
(60) Provisional application No. 60/906,102, filed on Mar. 9, 2007.

(51) Int. Cl. H04L 9/32; G06F 21/00

(52) U.S. Cl. 726/9

(57) ABSTRACT

An information processing system for remote access computing comprising a network access server and a local authentication server is augmented with the capability for forwarding authentication requests by tunneling interactions between the requesting client and an identity provider.

### CROSS-REFERENCE TO RELATED APPLICATIONS

This application claims the benefit of PPA Ser. No. 60/906,102 filed Mar. 9, 2007 by the present inventor, which is incorporated by reference.

### FEDERALLY SPONSORED RESEARCH

Not applicable

### SEQUENCE LISTING OR PROGRAM

Not applicable

### BACKGROUND OF THE INVENTION

1. Field of Invention

This invention relates generally to security in computer networks.

2. Prior Art

An Identity Metasystem is a collection of interoperable computing elements on a computer network which enables users of the services provided by the network to manage and exchange their digital identities. In an Identity Metasystem, an Identity Provider is a network server responsible for authenticating users, and a Relying Party is a network server which requires an authenticated user identity in order to provide service. The Identity Metasystem defines the mechanisms that enable a Relying Party to validate that a user requesting service from that Relying Party has been previously authenticated by an Identity Provider, in which the Relying Party is a web service based on the Simple Object Access Protocol (SOAP), or web server based on the Hypertext Transfer Protocol (HTTP).

The document “A Technical Reference for the Information Card Profile V1.0”, published in December 2006 by Microsoft Corporation, describes the network communication protocols by which an Identity Selector may obtain the token requirements of a Replying Party, then authenticate to an Identity Provider, and finally send a token obtained from an Identity Provider to a Relying Party. The protocols defined in “A Technical Reference for InfoCard v1.0 in Windows” specify a protocol exchange in which the protocols defined in the documents Web Services Security: SOAP Message Security 1.0 (WS-Security 2004), Web Services Trust Language (WS-Trust), Web Services Security Policy Language (WS-SecurityPolicy) and Web Services Metadata Exchange (WS-MetadataExchange), all of which are based on the Simple Object Access Protocol (SOAP), are to be used for the communication between the Identity Selector and the Relying Party. The Simple Object. Access Protocol is typically used only between applications in a web services framework.

The document “A Guide to Supporting InfoCard v1.0 Within Web Applications and Browsers”, published in March 2006 by Microsoft Corporation, describes the network communication protocols by which an Identity Selector may obtain the token requirements of a Relying Party and send a token obtained from an Identity Provider to a Relying Party using the Hypertext Transfer Protocol (HTTP) and Hypertext Markup Language (HTML). The Hypertext Transfer Protocol is typically used by a web browser to communicate with a web server to web application.

In a local area network based on the Institute of Electrical and Electronics Engineers, Inc. (IEEE) Ethernet standards for physical and data link network layers, computer systems are typically attached to the network either through a physical cable connection to a bridge, or to a radio connection to a wireless router. In both cases, the bridge and the wireless router function as a media access control device. A media access control device implements control functions that determine whether a computer system that has been attached to a port on the device is permitted to communicate on the network. Recent devices implement the IEEE standard 802.1X-2004 Port-Based Network Access Control, which specifies how the media access control device can prevent unauthorized access by computer systems. The device, termed the authenticator, will authenticate a computer system when that computer system, termed the supplicant, connects to it. If the supplicant successfully completes authentication with the authenticator, the supplicant will then be permitted to communicate with other computer systems on the network. If the supplicant does not complete authentication, the supplicant will not be permitted to further communicate with other computer systems on the network. IEEE standard 802.1X-2004 defines an encapsulation technique to carry protocol data units (PDUs) of the Extensible Authentication Protocol (EAP) over the LAN connection between the supplicant and the authenticator.

EAP is defined in IETF RFC 3748 “Extensible Authentication Protocol (EAP)” as an authentication framework intended for use with data link protocols. Within the EAP framework, the Protected Extensible Authentication Protocol (PEAP) encapsulates the authentication information within an encrypted Transport Layer Security (TLS) tunnel between the supplicant and the authenticator.

Existing prior art implementations of 802.1X with EAP and PEAP have been designed to have the network server forward the EAP PDUs it receives from supplicants to a local authentication server (46). As illustrated in FIG. 2, in a prior art implementation the local authentication server (46) may rely upon a local database (50) that stores the credentials of authorized users. In a prior art implementation, the network supplicant element of the client will use an EAP authentication mechanism to carry the user's identity and credentials to the local authentication server (46), that will compare those credentials with those stored for the user in the database (50).

In some prior art implementations of 802.1X with EAP, the supplicants do not have accounts on the local database, and instead, the local authentication server will forward the authentication credentials to a remote authentication server via the Remote Authentication Dial In User Service (RADIUS) protocol. This protocol requires a pre-established trust relationship between the local authentication server and the remote authentication server.

A limitation of these prior art implementations is that they do not define how a user whose computer is connecting to an access point that requires 802.1X authentication can specify their identity provider. Furthermore, these prior art implementations are limited as they require the organizations which maintain the authentication credentials of users in their user community to provide RADIUS servers accessible on the Internet to authenticate their users, and establish RADIUS trust relationships between the local authentication server and remote authentication server. Also, as the PDUs of the RADIUS protocol are carried in the UDP protocol above IP, they cannot be protected from eavesdropping or modification while in transit on the Internet using the Secure Sockets Layer (SSL) or Transport Layer Security (TLS) protocols.

### SUMMARY

This invention describes a method and system for authentication of a network supplicant when that network supplicant attaches to a media access control device. In this invention, the InfoCard protocols are carried in EAP PDUs from the supplicant to the authenticator, and then carried in SOAP and other HTTP-based protocols to the identity provider.

### DRAWINGS—FIGURES

FIG. 1 is a diagram that illustrates the components of the system for authentication upon network attachment.

FIG. 2 is a diagram that illustrates the components of a prior art system for authentication upon network attachment.

FIG. 3A and FIG. 3B are diagrams that illustrate the structure of protocol data units used in the invention.

FIG. 4A, FIG. 4B and FIG. 4C are a flowchart illustrating the operation of behavior of a client.

FIG. 5 is a flowchart illustrating the operation of a listening thread in a local authentication server.

FIG. 6A, FIG. 6B and FIG. 6C are a flowchart illustrating the operation of an association thread in a local authentication server.

FIG. 7 is a diagram illustrating components of a relying party computer network.

FIG. 8 is a diagram illustrating components of an identity provider computer network.

FIG. 9 is a diagram illustrating components of a server computer.

FIG. 10 is a diagram illustrating components of a workstation computer with a wireless network interface.

FIG. 11 is a diagram illustrating components of a wireless access point.

FIG. 12 is a diagram illustrating the tables of the local authentication server database.

FIG. 13 is a diagram illustrating the tables of the identity provider database.

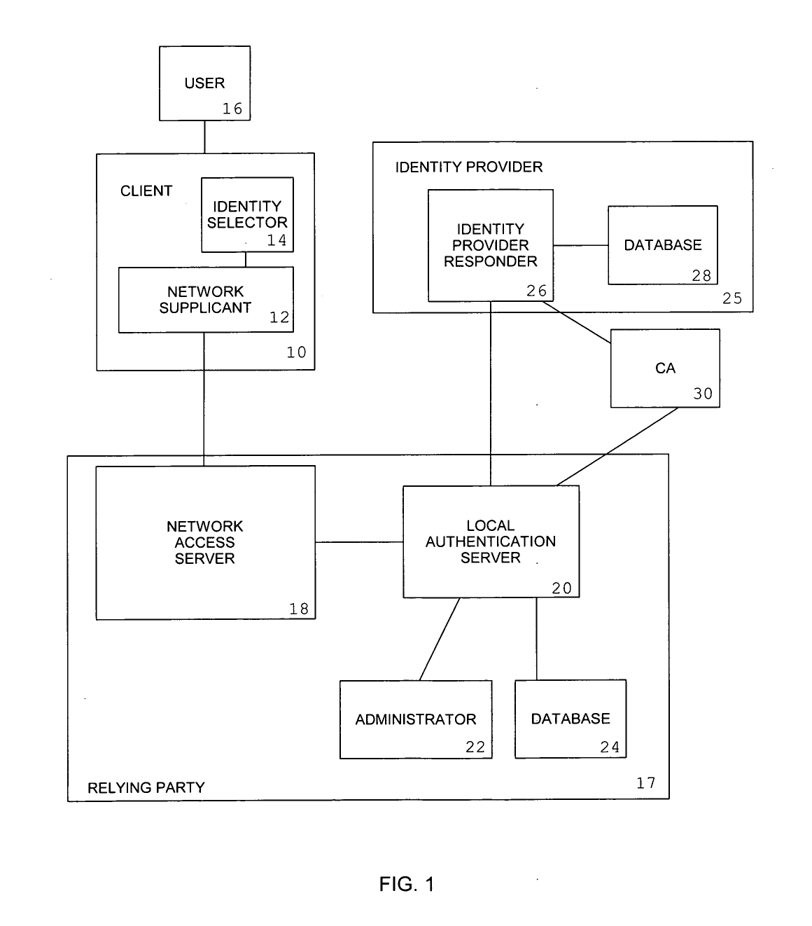

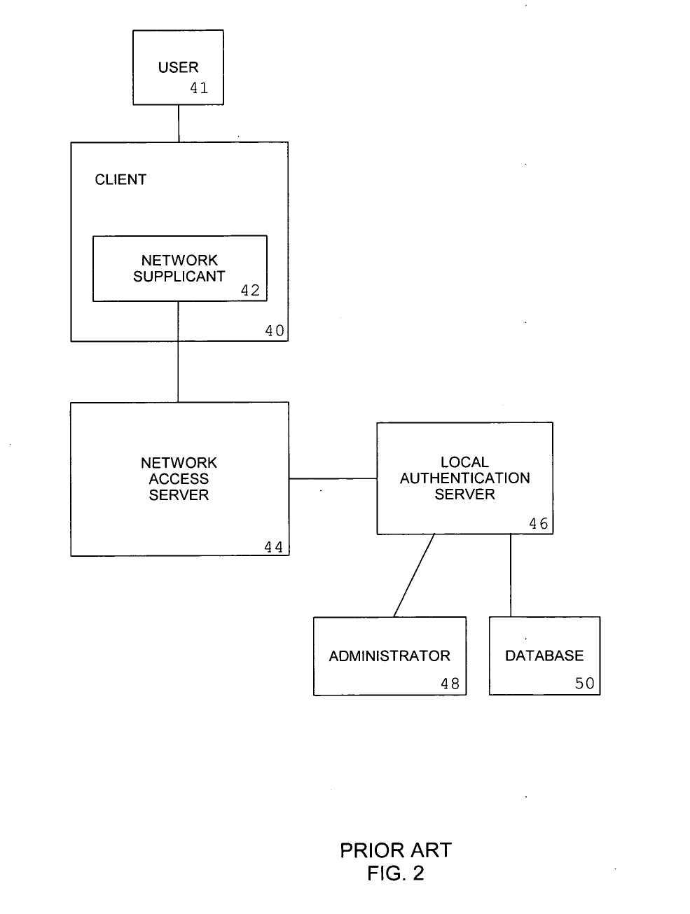

### DRAWINGS—REFERENCE NUMERALS

10 Client

12 Network supplicant

14 Identity selector

16 User

17 Relying party

18 Network access server

20 Local authentication server

22 Administrator

24 Local authentication server database

25 Identity provider

26 Identity provider responder

28 Identity provider database

30 Certification authority

40 Client

41 User

42 Network supplicant

44 Network access server

46 Local authentication server

48 Administrator

50 Database

62 EAP Expanded PDU

62 Parameter TLV PDU

64 Link IPv4 Address and Policy PDU

66 Sealed token PDU

68 Encapsulated DNS PDU

70 Encapsulated IP PDU

72 Completed PDU

240 Client computer

242 Relying party

244 Administrative console workstation computer

246 Wireless access point

248 LAN switch

252 Firewall router

254 ISP

256 Local authentication server computer

270 Identity provider

272 Administrative console workstation computer

274 ISP

276 Firewall router

278 DMZ switch

280 Internal firewall

282 Internal switch

284 Frontend web server computer

286 Application server computer

288 Database server computer

300 Computer

302 CPU

304 Hard disk interface

306 System bus

308 BIOS ROM

310 Hard disk

312 Operating system software on hard disk

314 Application software on hard disk

316 RAM

318 Operating system software in memory

320 Application software in memory

322 Network interface

324 LAN switch

340 Computer

342 CPU

344 Monitor

346 Video interface

348 System bus

350 USB interface

352 Keyboard

354 Mouse

356 Hard disk interface

358 BIOS ROM

360 Hard disk

362 Operating system on hard disk

364 Application on hard disk

366 RAM

368 Operating system in memory

370 Application in memory

372 Wireless network interface

380 Wireless access point

382 CPU

384 Flash memory

386 System bus

388 RAM

390 Wireless network interface

392 Network interface

394 LAN switch

400 Local user table

402 Identity provider table

404 Authorization table

410 User table

### DETAILED DESCRIPTION

The components of the system described in this invention are:
a client (10), which contains a network supplicant (12) and identity selector (14), and operates under the control of a user (16),
a network access server (18), which is notified by the media access control device when a network supplicant attaches to the network,
a local authentication server (20), which leverages a local database (24) and is managed by an administrator (22),
an identity provider responder (26), which leverages a database of authentication credentials (28), and
a certification authority (30), which issues certificates to the identity provider responders (26) and to local authentication servers (20).

The client (10) is typically a single computer system, such as a laptop or other mobile device.

The network supplicant (12) is a component of the operating system of the client (10). The supplicant will start negotiation when it is notified by the data link layer of the client that a packet has been received over an Ethernet connection from an authenticator. The network supplicant will handle the negotiation of authentication over this connection, and if the authentication is successfully completed, the authenticator will grant the client access to the network.

The identity selector (14) is a component of the operating system of the client (10). The identity provider implements the client role of the InfoCard protocols, and authenticates the user to the user's identity provider.

The network access server (18) is a component of a computer or device attached to the network of the relying party. It may be integrated with a media access control device, or alternatively a media access control device may forward EAP PDUs to the network access server. Typically in a large enterprise network there may be one or more network access servers for each network with an attached network access point, such as a wireless access point. When a supplicant connects to a port on a media access control device, the network access server will send an EAP-Request/EAP-Type=Identity PDU to the supplicant, and the supplicant will reply with an EAP-Response/EAP-Type=Identity PDU. The network access server will send this and subsequent EAP PDUs to a local authentication server (20).

The local authentication server (20) is a component of a computer or device attached to the network of the relying party.

The local authentication server database (24) can be implemented as a relational database. The tables of this database are the local user table (400), the identity provider table (402) and the authorization table (404).

The local user table (400) in the local authentication server database has one row for each user whose identity account is managed locally by the relying party. The primary key of this table is the USER UNIQUE ID column. The columns of this table are:
USER UNIQUE ID: a unique identifier for the user,
USER NAME: the username of the user,
CREDENTIALS: the authentication credentials for the user, such as a password,
STATE: the status of the user's account,
LAST SUCCESSFUL LOGIN DATE: the date and time that the user last successfully authenticated, and
LAST LOGIN FAILURE DATE: the date and time that the user last supplied incorrect credentials during authentication.

The identity provider table (402) in the local authentication server database has one row for each identity provider supported for use in authentication by the relying party. The primary key of this table is the IDP ID column. The columns of this table are:
IDP ID: a unique identifier for the identity provider,
LOGIN URL: the Uniform Resource Locator (URL) which clients use to log into the identity provider,
TOKEN FORMAT: the format of tokens generated by this identity provider,
ISSUER URL: the URL specified by the identity provider as the issuer attribute in a Security Assertion Markup Language (SAML) assertion,
STATE: the status of the identity provider's support for use in authentication by the relying party, and
CERTIFICATE PATH: the certificate path of the identity provider.

The authorization table (404) in the local authentication server database has one row for each identity provider or user with special access rights in the relying party. The columns of this table are:
IDP ID: the unique identifier for the identity provider, or NULL if the user is a locally authenticated user,
USER ID: the unique identifier for the user, or NULL if the access rights apply to all users authenticated at a particular identity provider or locally,
ACCESS RIGHTS: the access rights of the user, and
STATE: the status of the user's access rights grant at the relying party.

The identity provider responder (26) is a network service offered to relying parties by an identity provider. The behavior of this service is described in the document “A Technical Reference for the Information Card Profile V1.0”.

The identity provider database (28) can be implemented as a relational database. There is one table in this database, the user table (410).

The user table (410) in the identity provider database has one row for each user whose identity account is managed by the identity provider. The columns of this table are:
USER UNIQUE ID: a unique identifier for the user,
USER NAME: the username of the user,
CREDENTIALS: the authentication credentials for the user, such as a password,
STATE: the status of the user's account,
LAST SUCCESSFUL LOGIN DATE: the date and time that the user last successfully authenticated, and
LAST LOGIN FAILURE DATE: the date and time that the user last supplied incorrect credentials during authentication.

The certification authority (30) issues X.509 public key certificates to the identity provider responder and local authentication server. It is necessary for the identity provider responder and the local authentication server to have X.509 certificates for use as TLS server certificates. The identity selector needs to have a copy of the certification authority's certificate as a trusted certificate to be able to perform a validation of the identity provider responder's certificate and the local authentication server's certificate. Prior to the authentication process, the identity provider responder and the local authentication server will each have generated a public and private key pair, and the certification authority will have generated X.509 public key certificates which sign the identity and public key of each of these servers using the private key of the certification authority.

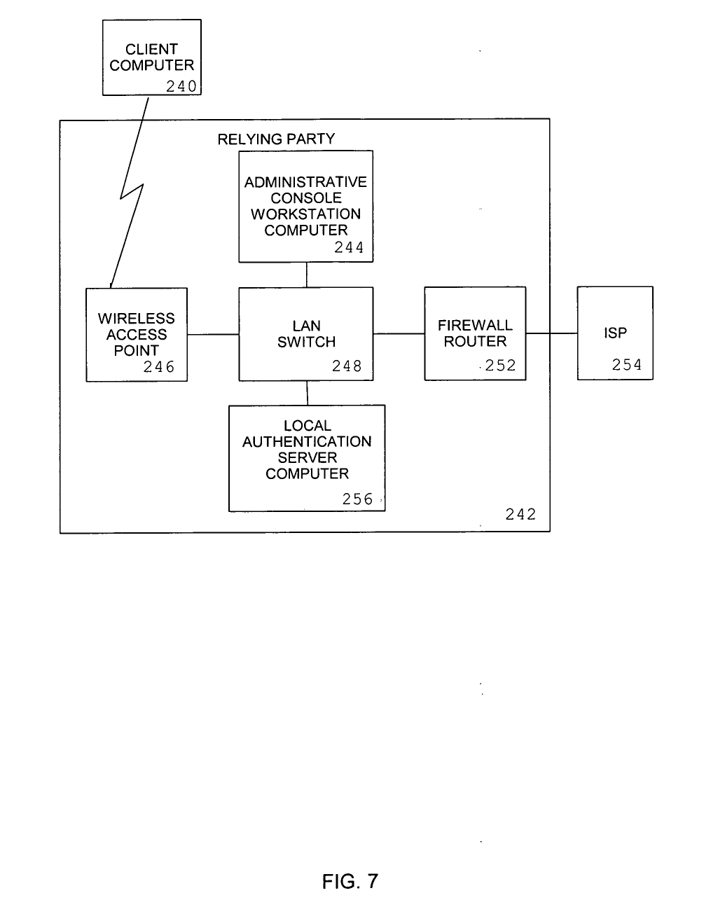

The diagram of FIG. 7 illustrates the typical deployment of network components of a relying party (17) which provides Internet access to clients which are connecting to a local wireless access point. The wireless access point (246) is connected to a LAN switch (248). A firewall router (252) which provides Internet connectivity via a connection to an Internet Service Provider (ISP) (254) is also connected to this LAN switch.

The client (10) can be implemented as software on the client computer (240). The client computer uses a radio link to the wireless access point (246) of the relying party.

The network access server (18) can be implemented as software running on a wireless access point (246).

The local authentication server (20) can be implemented as server software running on a local authentication server computer (256). The local authentication database (24) can be implemented as database software also running on that local authentication server computer (256).

The interface for the administrator (22) to manage the local authentication server can be implemented as software running on an administrative console workstation computer (244).

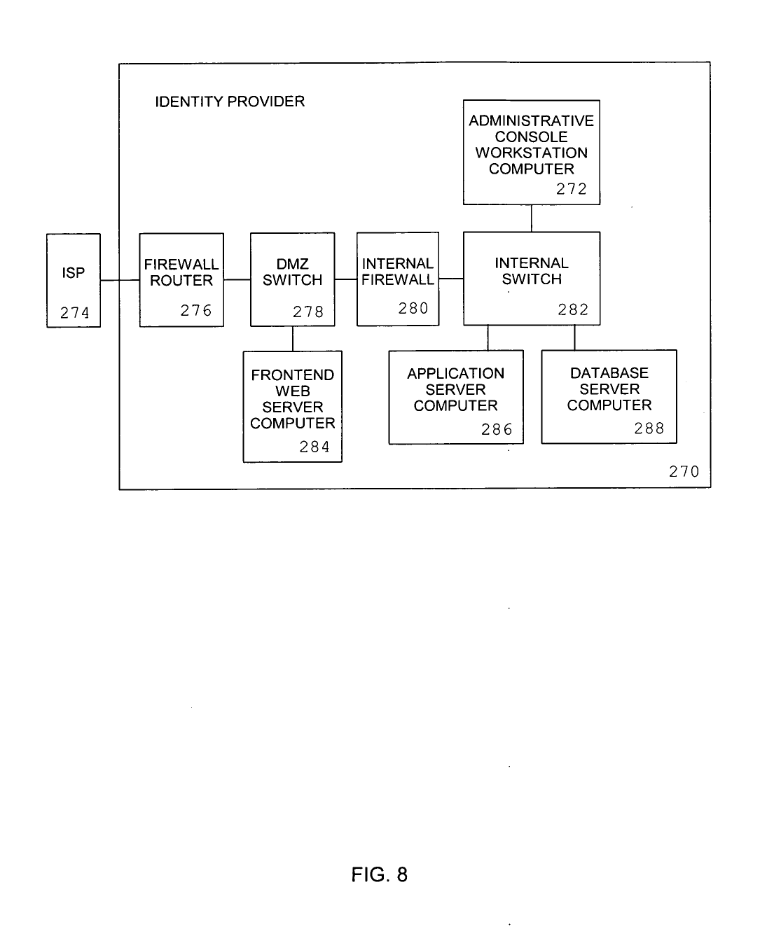

The diagram of FIG. 8 illustrates the typical deployment of network components of an identity provider (25). The identity provider network (270) receives incoming authentication requests from its ISP (274). These requests are directed by the firewall router (276) to the frontend web server computer (284). The software running on the frontend web server computer will validate the appropriateness of the requests, and if correct, forward the requests to identity provider responder software running on an application server computer (286).

The identity provider responder (26) can be implemented as server software running on an application server computer (286).

The identity provider database (28) can be implemented by database software running on a database server computer (288).

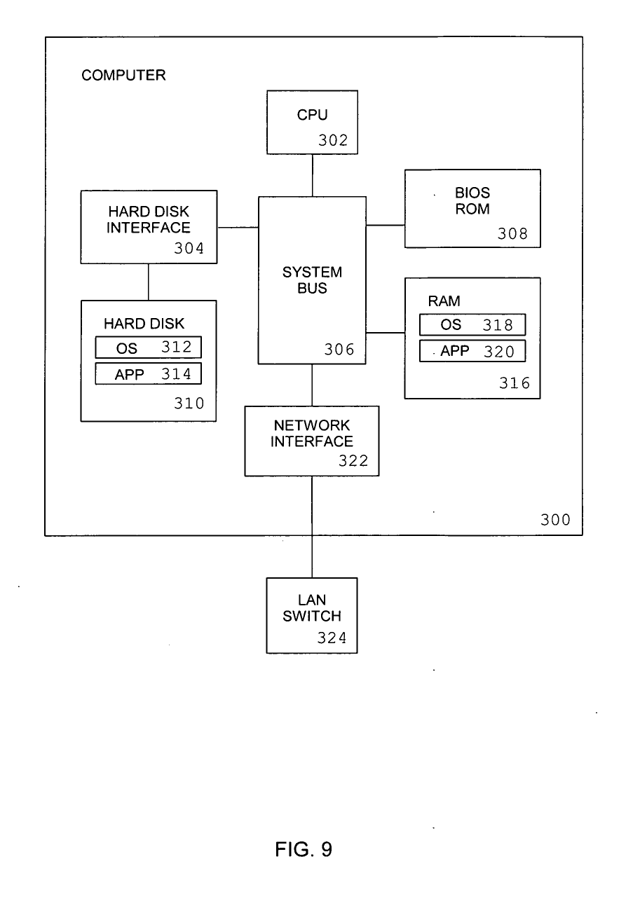

The diagram of FIG. 9 illustrates the typical components of a computer for running server software applications. The components of the computer (300) include a central processing unit (302), a hard disk interface (304) to a hard disk (310), a system bus (306), a BIOS ROM (308), random access memory (316), and a network interface (322) to a LAN switch (324). The hard disk stores the persistent state of the operating system (312) and server applications (314). The random access memory holds the currently running software and state of the operating system (318) and server applications (320).

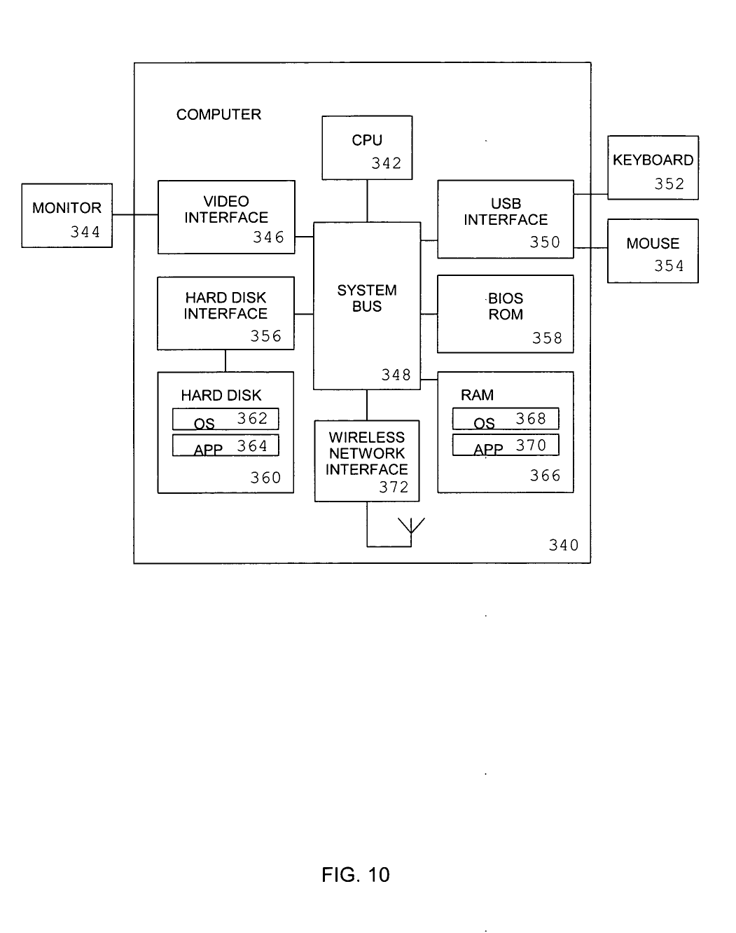

The diagram of FIG. 10 illustrates the typical components of a computer, such as a portable system, with a wireless network interface. The components of the computer (340) include a central processing unit (342), a video interface (346) to a monitor (344), a hard disk interface (356) to a hard disk (360), a USB interface (350) to a keyboard (352) and mouse (354), a BIOS ROM (358), a wireless network interface (372) and random access memory (366). The hard disk stores the persistent state of the operating system (362) and applications (364). The random access memory (366) holds the currently running software and state of the operating system (368) and applications (370).

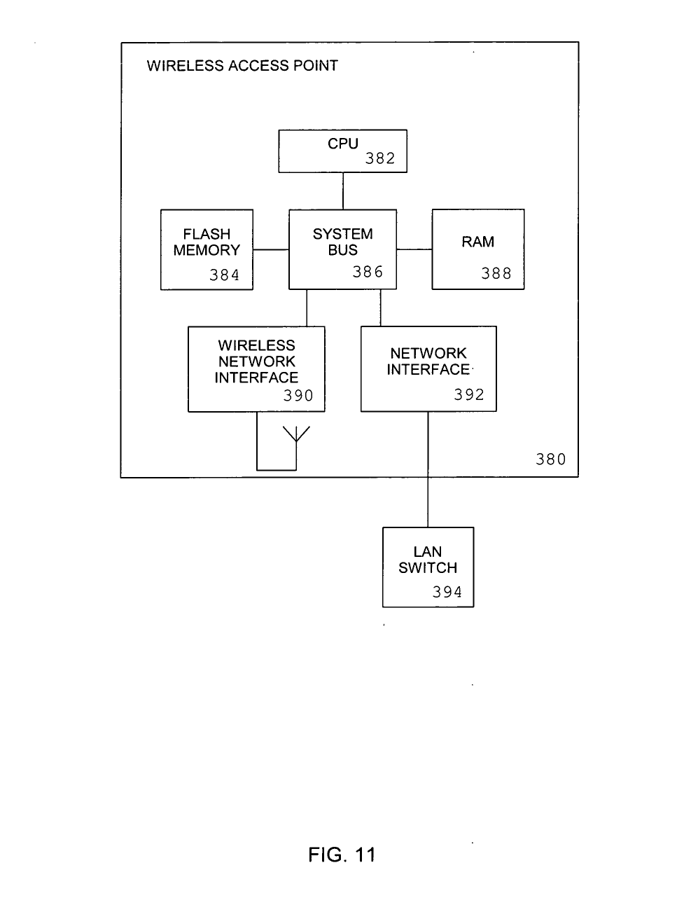

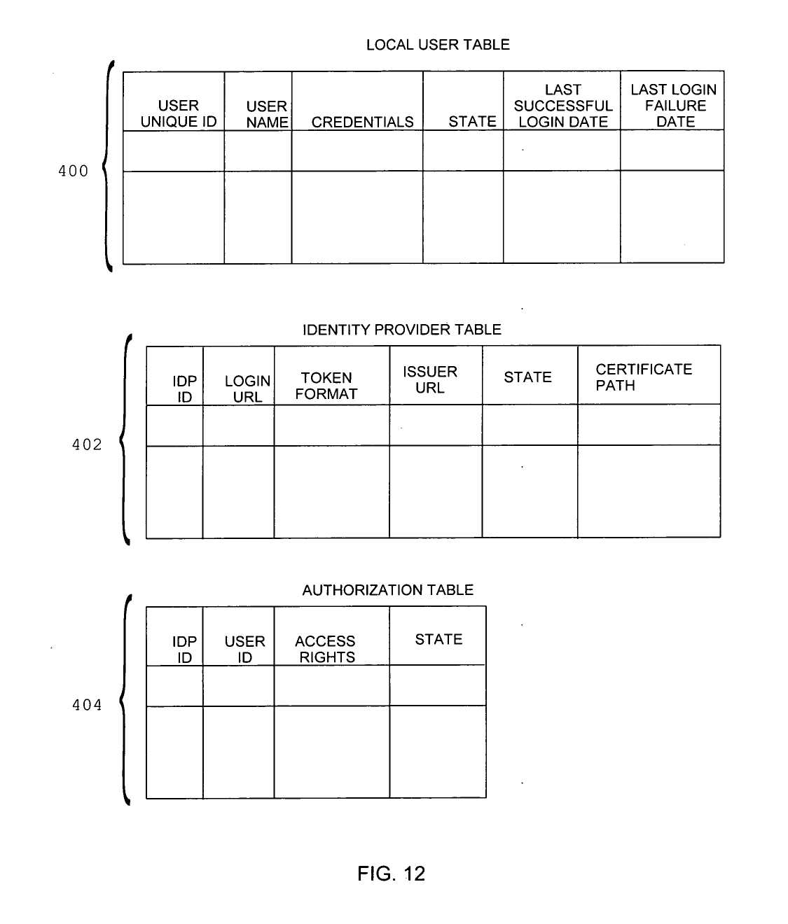

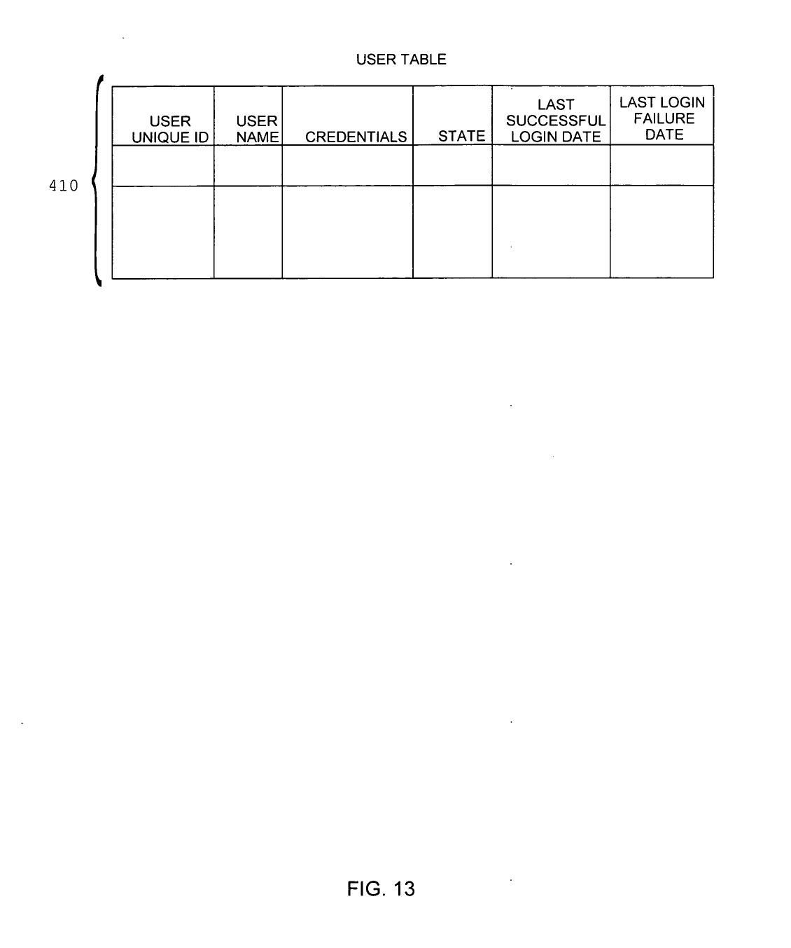

The diagram of FIG. 11 illustrates the typical components of a wireless access point. The components of a wireless access point (380) include a central processing unit (382), a system bus (386), flash memory (384), random access memory (388), a wireless network interface (390) and a network interface (392) to a LAN switch (394).

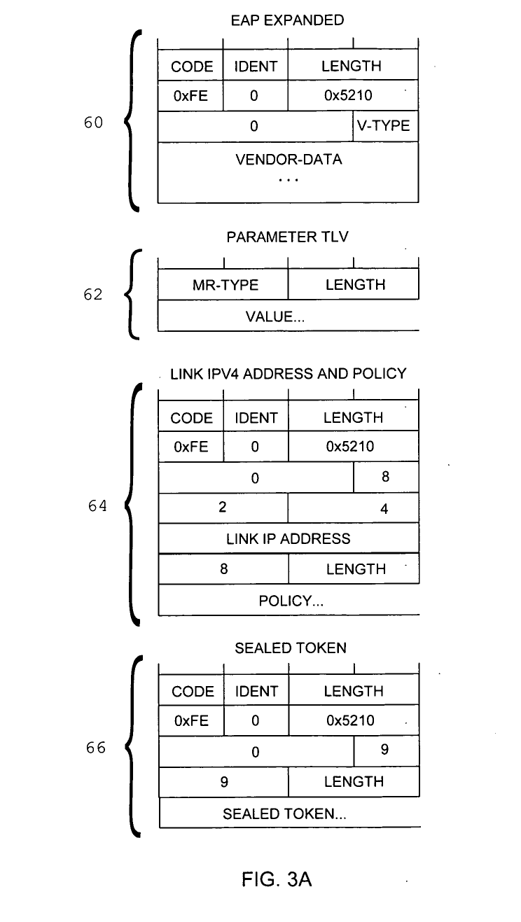

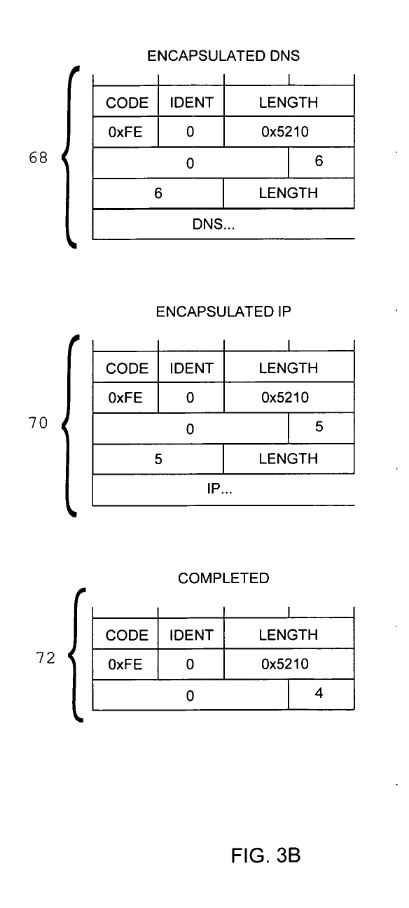

This invention defines several PDUs which can be carried in an EAP Expanded Type PDU (60), as illustrated in FIG. 3A and FIG. 3B. In these PDUs, the Type is 0xFE and the Vendor ID is 0x5210.

In the Link IPv4 address and policy PDU (64), the Vendor-Type is 8, and two TLV parameters are present as the Vendor-Data: a link IP address parameter of MR-Type 2 and length 4, and a policy parameter of MR-Type 8. The value of the link IP address parameter is an IP address that the client should use as its own address in encapsulated IP PDUs. The value of the policy parameter is an XML document with the structure specified by WS-SecurityPolicy.

In the Sealed token PDU (66), the Vendor-Type is 9, and one TLV parameter is present as the Vendor-Data: a sealed token parameter of MR-Type 9. The value of the sealed token parameter is an XML document based on XML Encryption, which contains an encrypted symmetric key, and a token encrypted with that symmetric key.

In the Encapsulated DNS PDU (68), the Vendor-Type is 6, and one TLV parameter is present as the Vendor-Data: a DNS parameter of MR-Type 6. The value of the DNS parameter is a DNS message, as defined by the document “DOMAIN NAMES—IMPLEMENTATION AND SPECIFICATION” (RFC 1035) by Paul Mockapetris in November 1987.

In the Encapsulated IP PDU (70), the Vendor-Type is 5, and one TLV parameter is present as the Vendor-Data: an IP parameter of MR-Type 5. The value of the IP parameter is an Internet Protocol PDU, as defined by the document “INTERNET PROTOCOL” (RFC 791) by John Postel in September 1981.

In the Completed PDU (72), the Vendor-Type is 4, and the Vendor-Data is empty.

### Operations

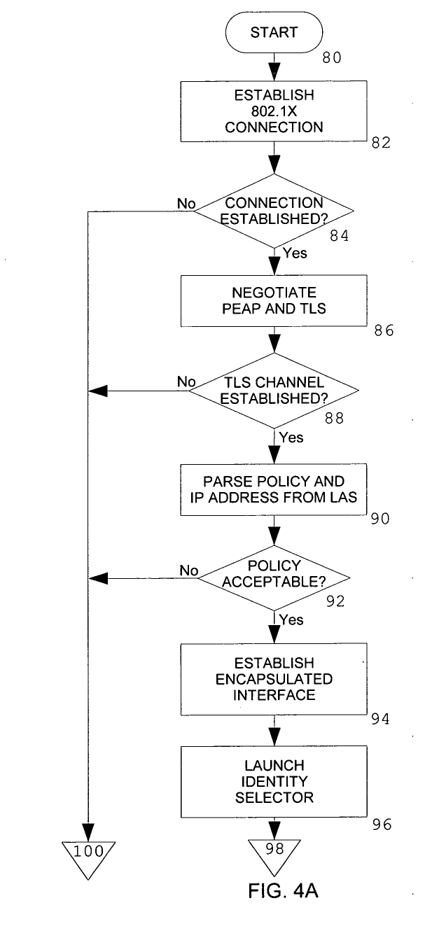

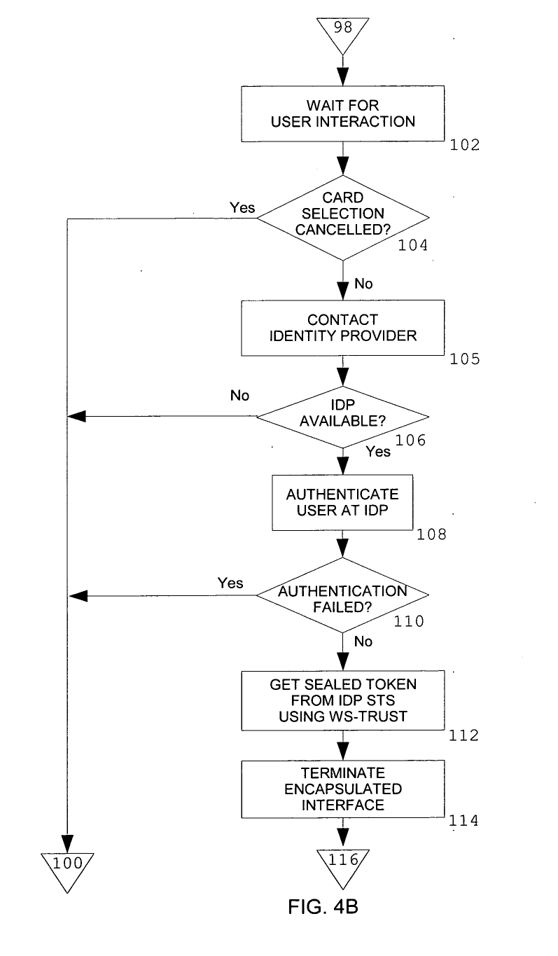

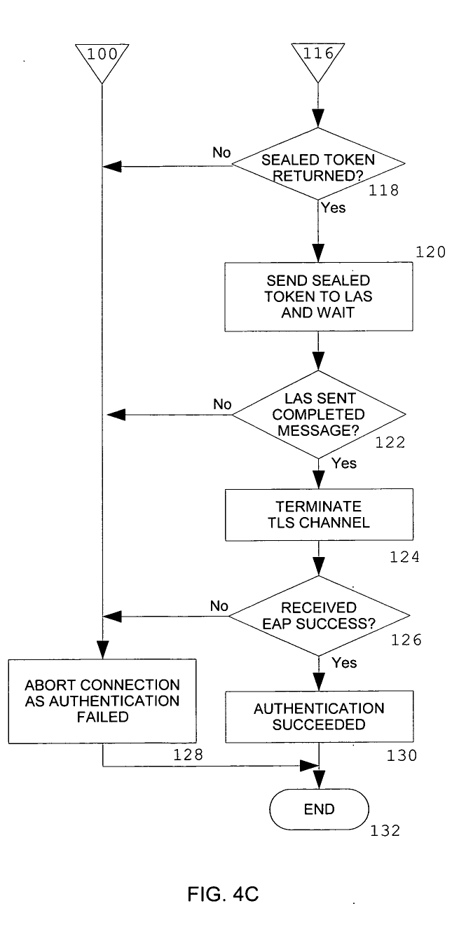

The behavior of a client in this invention is illustrated by the flowchart of FIG. 4A, FIG. 4B, and FIG. 4C. At step 82, when a client attaches to a network, the supplicant component of the client will receive notification from the authenticator that 802.1X authentication is necessary, and will establish an 802.1X connection to the network access server. In the connection procedure, the network access server will send an EAP-Request/EAP-Type=Identity PDU to the supplicant, and the supplicant will reply with an EAP-Response/EAP-Type=Identity PDU. At step 84, if the connection cannot be established, the authentication process will have failed. Otherwise, at step 86, the supplicant will negotiate the use of PEAP and the PEAP-TLS mechanisms. In the negotiation procedure, the network access server will send an EAP-Request/EAP-Type=PEAP PDU with version=2, PEAP Start, and S bit set; the supplicant will reply with an EAP-Response/EAP-Type=PEAP PDU with version=2 and a TLS client_hello; the network access server will send an EAP-Request/EAP-Type=PEAP PDU with version=2, a TLS server_hello, a TLS certificate, a TLS server_hello_done; the supplicant will reply with an EAP-Response/EAP-Type=PEAP PDU with version=2, with a TLS client_key_exchange, a TLS change_cipher_spec, and a TLS finished; the network access server will send an EAP-Request/EAP-Type=PEAP PDU with a TLS change_cipher_spec and a TLS finished, and within the TLS channel, an EAP-Payload TLV with an EAP-Request/EAP-Type=EXPANDED PDU, with two parameters: a link IP address parameter, and a policy parameter (64). At step 88, if the TLS channel cannot be established, the authentication process will have failed. Otherwise, subsequent messages are exchanged between the supplicant and the local authentication server. These messages are tunneled through the network access server and are encapsulated within the TLS channel. At step 90, the client will validate the authentication policy requirements information received from the network authentication server. The authentication policy requirements information is an XML document structured according to the requirements of the WS-SecurityPolicy specification, which allows the relying party to indicate any required claim types or required identity providers.

At step 92, if the policy is not acceptable, the authentication process will have failed. Otherwise, if the policy is acceptable, at step 94 the client will establish a virtual network interface on the local system, with the local IP address set to the IP address provided in the link IP address field of the EAP Expanded PDU (64). The virtual network will advertise a default route to the Internet. While the virtual network is in place, IP packets sent to this interface will be wrapped in an encapsulated IP EAP Expanded PDU (70). DNS packets will be wrapped in an encapsulated DNS EAP Expanded PDU (68).

At step 96, the client will launch an identity selector. The identity selector will present the user with a set of InfoCards. If the policy sent by the network access server included a set of required claims, only those cards meeting those claims will be displayed. If the policy sent by the network access server included a list of identity providers, only InfoCards issued by one of those identity providers will be displayed. At step 104, if no cards meet the requirements, or the user does not select a card and cancels the interaction, then the authentication process will have failed.

Otherwise, at step 105, the identity selector will establish a connection to the identity provider over the virtual interface. At step 106, if the identity provider is not available, then the authentication process will have failed. At step 108, the identity selector will authenticate the user at the identity provider, and provide the public key of the local authentication server obtained from the TLS certificate. If the identity provider indicates that the user could not be authenticated, then at step 110 the authentication process will fail.

If the authentication is successful, then at step 112 the identity selector will obtain from the identity provider, using the WS-Trust protocol, a token sealed for the local authentication server. At step 114, the client will then terminate the encapsulated network interface. At step 118, if no sealed token was returned, then the authentication process will have failed.

If a sealed token was returned, then at step 120 the client will send the sealed token to the local authentication server using an EAP Expanded request with a “sealed token” parameter (66). At step 122, if the local authentication server responds with an EAP Expanded response with a completed parameter (72), then at step 124 the client will terminate the TLS channel and await an EAP Success message. At step 126, if the EAP Success message is received, the authentication has succeeded and the 802.1x process will complete successfully. If however the local authentication server did not send an EAP Expanded response with a completed parameter (74), or did not send an EAP Success message before a timeout is reached, then the authentication process will have failed.

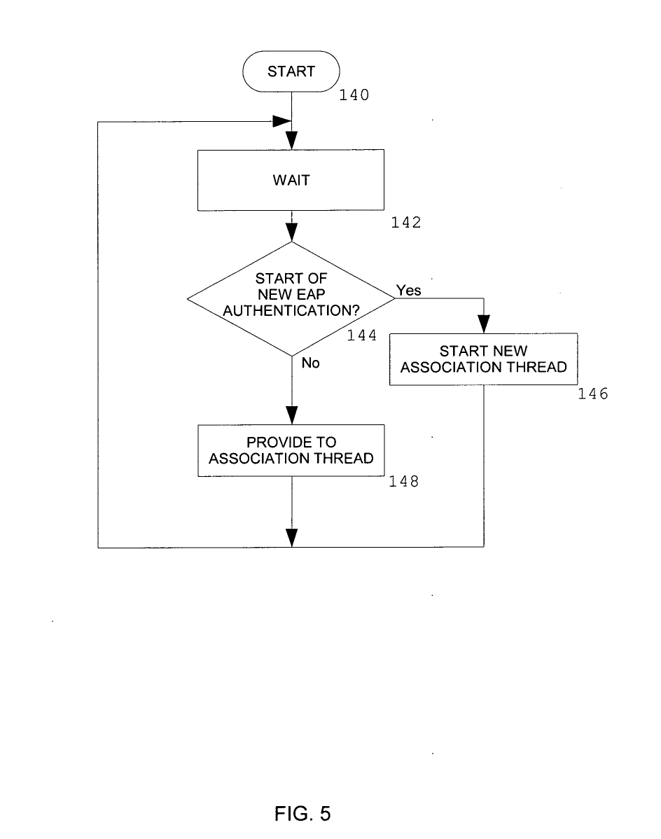

The behavior of a listening thread in a local authentication server is illustrated by the flowchart of FIG. 5. At step 142, the listening thread will wait for an incoming EAP PDU from network access servers. At step 144, the thread will determine if the PDU is an EAP-Response/EAP-Type=Identity PDU, indicating a new authentication attempt for which there is no existing thread in the local authentication server. If there is no existing thread, then at step 146 the thread will start a new association thread. Otherwise, at step 148, the thread will provide the PDU to the association thread for this association.

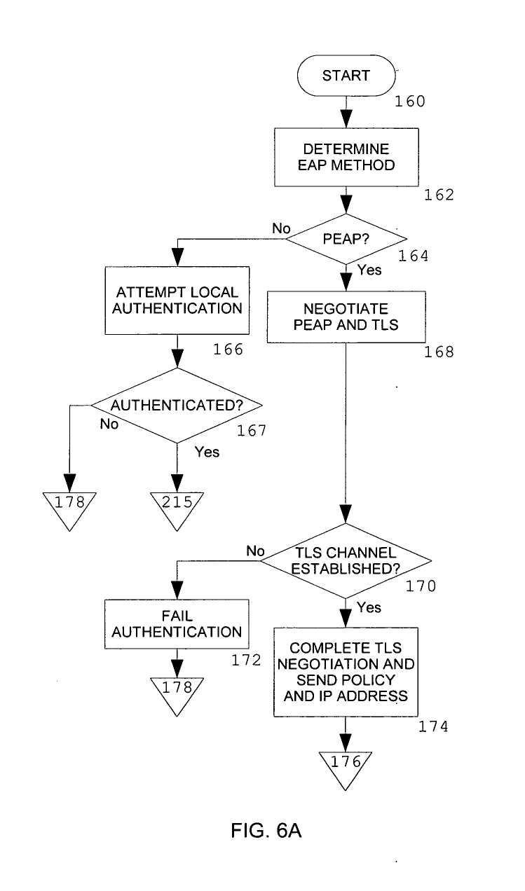

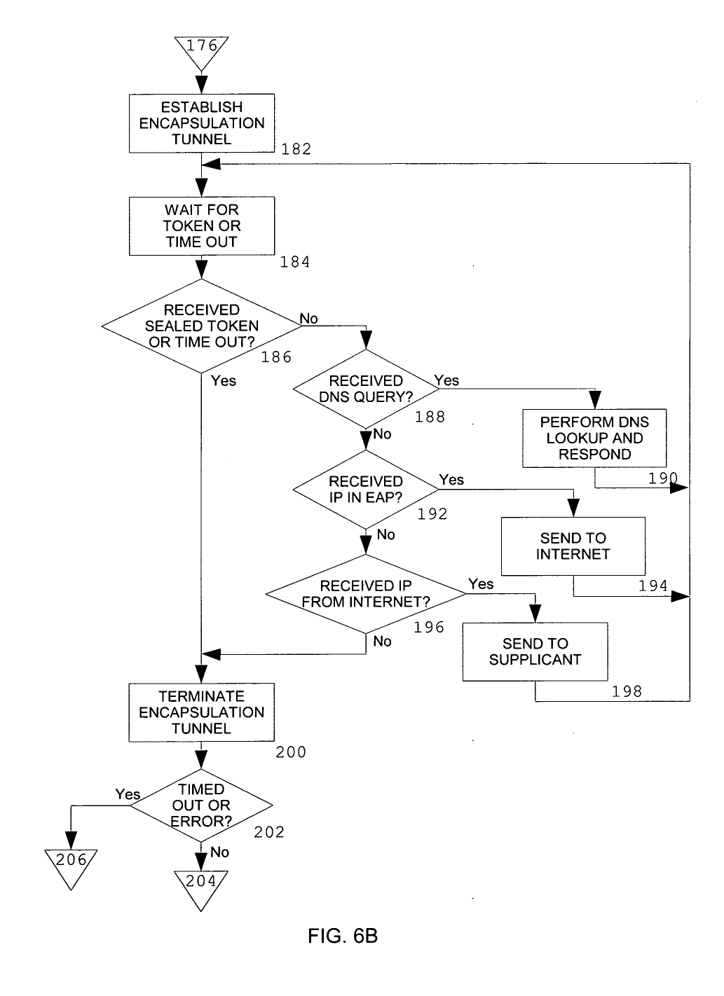

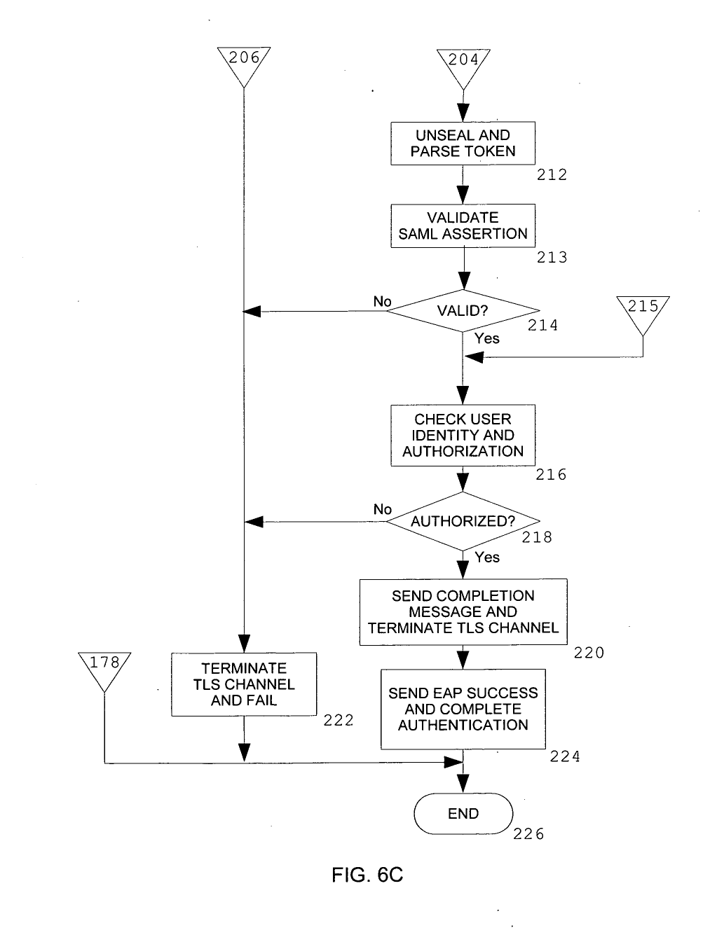

The behavior of an association thread in a local authentication server is illustrated by the flowchart of FIG. 6A, FIG. 6B and FIG. 6C. At step 162, the thread will determine the EAP method to use for the client, by looking for a row in the local database local user table (400) in which the identity supplied by the client matches the value in the USER NAME column. If a row is found, then the PEAP-TLS method described in this invention will not be used, and at step 166 the thread will use the local database local user table (400) to authenticate the user. If the supplied credentials do not match, then the authentication fails. Otherwise, the thread will check the user's identity and authorization, by looking for a row in the authorization table (404) in which the value of the IDP ID column is NULL and the user unique identifier supplied by the local user table matches a value of the USER ID column. At step 218, if the thread could not locate rows which grant access rights to the user, or the access rights do not permit authentication upon network attachment, then the thread will terminate the TLS channel and fail the authentication. Otherwise, at step 220, the thread will send a completion message (72) to the client and terminate the TLS channel. At step 224, the thread will send an EAP Success PDU to the client and complete the authentication, signaling to the network access server to allow the client access to the network.

If the client identity is not found for a local user, then at step 168 the thread will negotiate the PEAP and PEAP-TLS mechanisms. In the negotiation procedure, the thread will send an EAP-Request/EAP-Type=PEAP PDU with version=2, PEAP Start, and S bit set to the supplicant; the supplicant will reply with an EAP-Response/EAP-Type=PEAP PDU with version=2 and a TLS client_hello; the thread will send an EAP-Request/EAP-Type=PEAP PDU with version=2, a TLS server_hello, a TLS certificate, a TLS server_hello_done; the supplicant will reply with an EAP-Response/EAP-Type=PEAP PDU with version=2, with a TLS client_key_exchange, a TLS change_cipher_spec, and a TLS finished. At step 170, if the TLS channel could not be established, then at step 172 the thread will fail the authentication.

At step 174, the thread will complete the TLS negotiation and send the authentication policy and IP address to the client. The thread will send an EAP-Request/EAP-Type=PEAP PDU with a TLS change_cipher_spec and a TLS finished, and within the TLS channel, an EAP-Payload TLV with a EAP-Request/EAP-Type=EXPANDED, with two parameters: a link IP address parameter, and a policy parameter (64). At step 182, the thread will establish an encapsulation tunnel for the client using a network address translation, and start a timer.

At step 184, the thread will wait for incoming EAP PDUs, incoming PDUs from the Internet that are replies from earlier requests, or a timer expiration event. At step 188, the thread will check whether the incoming PDU is an encapsulated DNS query (68) received from the client. If it is, then at step 190 the thread will perform a DNS lookup as requested by the client, and respond to the client. At step 192, the thread will check whether the incoming PDU is an encapsulated IP packet (70). If it is, then at step 194 the thread will send the contents of the PDU to the Internet (194). At step 196, the thread will check whether the incoming PDU was received from the Internet. If it is, then at step 198 the thread will encapsulate the IP packet (70) and send it to the supplicant.

If the thread receives a sealed token PDU (66) from the client, an error occurred, or the thread timed out the association, then at step 200 the thread will terminate the encapsulation tunnel. If the thread timed out the association, then the thread will terminate the TLS channel and fail the authentication. Otherwise, at step 212 the thread will unseal and parse the token. The sealed token is an XML document based on XML Encryption, which contains an encrypted symmetric key, and a token encrypted with that symmetric key. The thread will decrypt the symmetric key, using the private key for its TLS certificate's public key. The thread will next decrypt the token using this symmetric key. The token is a Security Assertion Markup Language (SAML) assertion, in a format defined in the document “Assertions and Protocols for the OASIS Security Assertion Markup Language (SAML) V2.0”, edited by Scott Cantor, John Kemp, Rob Philpott and Eve Maler. At step 213, the thread will validate the SAML assertion. The thread will lookup the identity provider in the identity provider table (402) by finding a row in which the issuer attribute of the SAML assertion matches a value in the ISSUER URL column. If the token could not be decoded, the assertion is not properly formatted, or is not from a recognized identity provider, then at step 214 the thread will terminate the TLS channel and fail the authentication. At step 216, the thread will check the user's identity and authorization, by looking for a row in the authorization table (404) in which the identity provider unique identifier from the identity provider table matches a value of the IDP ID column, and a row in the authorization table in which the identity provider unique identifier from the identity provider table matches a value of the IDP ID column and the user unique identifier supplied by the identity provider in the SAML assertion matches a value of the USER ID column. At step 218, if the thread could not locate rows which grant access rights to the user, or the access rights do not permit authentication upon network attachment, then the thread will terminate the TLS channel and fail the authentication. Otherwise, at step 220, the thread will send a completion message (72) to the client and terminate the TLS channel. At step 224, the thread will send an EAP Success PDU to the client and complete the authentication, signaling to the network access server to allow the client access to the network.

### CONCLUSIONS

Many different embodiments of this invention may be constructed without departing from the scope of this invention. While this invention is described with reference to various implementations and exploitations, and in particular with respect to systems for authentication in computer networks, it will be understood that these embodiments are illustrative and that the scope of the invention is not limited to them.

What is claimed is:

1. A method for authenticating a client to a network access server, said method comprising
(a) connecting said client to said network access server,
(b) transmitting a policy from a local authentication server to said client via said network access server,
(c) establishing a tunnel to permit access to an identity provider via said network authentication server and said local authentication server,
(d) transmitting within said tunnel an authentication request from said client to an identity provider responder of said identity provider,
(e) authenticating said client based on said authentication request,
(f) generating an authentication token,
(g) transmitting said authentication token from said identity provider responder to said client within said tunnel,
(h) transmitting said authentication token from said client to said local authentication server via said network access server,
(i) validating said authentication token, and
(j) configuring said network access server to permit network access to said client.

2. The method of claim 1, wherein said transmitting of said policy from said local authentication server to said client via said network access server further comprises transmitting a public key certificate of said local authentication server.

3. The method of claim 2, wherein said transmitting of said authentication request from said client to said identity provider responder further comprises transmitting said public key certificate of said local authentication server.

4. The method of claim 3, wherein said generating of said authentication token comprises encrypting an authentication indication with a public key of said local authentication server obtained from said public key certificate of said local authentication server.

5. The method of claim 4, wherein said validating of said authentication token comprises decrypting said authentication token with a private key of said local authentication server.

6. The method of claim 1, wherein said transmitting of said authentication token from said client to said local authentication server via said network access server comprises sending said authentication token from said local authentication server to said network access server encoded as an extensible authentication protocol request within a remote access dial in user service protocol.

7. The method of claim 1, wherein said configuring said network access server to permit network access to said client comprises sending an access policy from said local authentication server to said network access server within a remote access dial in user service protocol.

8. The method of claim 1, wherein said transmitting of said authentication request from said client to said identity provider responder comprises transmitting an identity and a credential of said client from said client to said identity provider responder.

9. The method of claim 8, wherein said authenticating said client based on said authentication request comprises comparing said identity and said credential with a record corresponding to said identity obtained from a database of said identity provider.

10. The method of claim 1, wherein said transmitting said policy from said local authentication server to said client via said network access server comprises encoding said message according to an extensible authentication protocol.

11. A system for authenticating a client to a network access server, said system comprising
(a) said client,
(b) said network access server,
(c) a local authentication server, and
(d) an identity provider responder, wherein
said client connects to said network access server,
said local authentication server transmits a policy to said client via said network access server,
said local authentication server establishes a tunnel to permit access by said client to said identity provider responder,
said client transmits within said tunnel an authentication request from said client to said identity provider responder,
said identity provider responder authenticates said client based on said authentication request,
said identity provider responder generates an authentication token,
said identity provider responder transmits within said tunnel said authentication token to said client,
said client provides said authentication token to said local authentication server via said network access server,
said local authentication server validates said authentication token, and said local authentication server configures said network access server to permit network access to said client.

12. The system of claim 11, wherein said local authentication server is implemented as software running on a general-purpose computer system.

13. The system of claim 11, wherein said policy transmitted from said local authentication server to said client via said network access server comprises a public key certificate of said local authentication server.

14. The system of claim 13, wherein said authentication request transmitted from said client to said identity provider responder comprises said public key certificate of said local authentication server, an identity of said client, and a credential of said client.

15. The system of claim 14, wherein said identity provider responder generates an authentication token by encrypting an authentication indication with a public key of said local authentication server obtained from said public key certificate of said local authentication server.

16. The system of claim 11, wherein said client provides said authentication token to said local authentication server via said network access server encoded as an extensible authentication protocol request within a remote access dial in user service protocol.

17. A computer program product within a computer usable medium with software for authenticating a client to a network access server, said computer program product comprising
(a) instructions for transmitting a policy from a local authentication server to said client via said network access server,
(b) instructions for establishing a tunnel to permit access to an identity provider via said network authentication server and said local authentication server,
(c) instructions for transmitting within said tunnel an authentication request from said client to an identity provider responder of said identity provider,
(d) instructions for authenticating said client based on said authentication request,
(e) instructions for generating an authentication token,
(f) instructions for transmitting said authentication token from said identity provider responder to said client within said tunnel,
(g) instructions for transmitting said authentication token from said client to said local authentication server via said network access server,
(h) instructions for validating said authentication token, and
(i) instructions for configuring said network access server to permit network access to said client.
